(19) United States
(12) Patent Application Publication
(10) Pub. No.: US 2003/0061059 A1
(43) Pub. Date: Mar. 27, 2003

(54) Lodging facility and method of collecting guest images

(76) Inventor: Manu Ghela, Mesa, AZ (US)

Correspondence Address: Kenneth C. Booth, Schmeiser, Olsen & Watts LLP, 18 East University Drive, #101, Mesa, AZ, 85201, US

(21) Appl. No.: 09/964,124

(22) Filed: Sep. 25, 2001

(51) Int. Cl. G06F 17/60

(52) U.S. Cl. 705/1

(57) ABSTRACT

A lodging facility is disclosed, the lodging facility being configured to enable collection of images of guest activities at the lodging facility. In a first aspect of the invention, a plurality of video/audio cameras are placed in each of a plurality of rooms within the lodging facility and associated with an image control center for collecting images of guests within their rooms. In a second aspect of the invention, the collected images are displayed for the commercial purposes of the lodging facility such as in advertising, on the Internet, to other guests within the facility, or are edited and sold to the public.

### BACKGROUND OF THE INVENTION

1. Technical Field

This invention generally relates to a lodging facility configured to collect images of guests, and more specifically to a lodging facility and method of collecting images of guest activities for use in the lodging facility's commercial purposes.

2. Background Art

People have an innate sense of curiosity regarding the actions of others. This curiosity is so widespread that one generally recognized hobby is “people watching.” Movies and television programming, at times, also focuses on providing the public with opportunities for watching how people act or how they would hypothetically act in certain situations to satisfy the public curiosity for watching the activities of others. Yet another example of the fascination that people have with people watching is the use of “webcams” placed at notorious locations to enable people anywhere in the world to see the location and the people populating that location. For example, presently the Internet includes Internet cameras displaying the activities of people and the views at locations including the streets of New York, views of Boston, the beach at Belmar, N.J., views of the main decks of cruise ships, and many other views of public places.

Lodging facilities such as hotels, motels, bed-and-breakfasts, and the like, and their standard operation and usefulness are well known in the art. Conventionally, however, the specific activities of guests to the lodging facility behind closed doors is unknown to the public. Oftentimes, it would be advantageous for a lodging facility to show the public the specific activities of its guests to encourage others to visit, to promote the lodging facility, to satisfy the peculiar interests of the public in observing the actions of others, or for other commercial purposes.

### DISCLOSURE OF THE INVENTION

The present invention relates to a lodging facility which has been adapted to collect and display images of guests to the lodging facility while they are in their rooms or in other locations in the facility. According to a first aspect of the invention, each of a plurality of rooms within the lodging facility is equipped with a camera or other device for collecting images of the guests within the rooms. The cameras may be hidden or obvious. Each guest to the lodging facility is granted stay in a room upon giving their consent to the lodging facility's use of the guest's images for the lodging facility's commercial purposes. The lodging facility's commercial purposes may include such purposes as use of the images in advertising for the facility, display of the images on the Internet, and selling edited versions of the images. In exchange for giving their consent, guests may be granted a reduced rate on the cost of their stay, or a free stay at the lodging facility. In a particular embodiment of the invention, each room is provided with an interactive display through which guests may access images of and observe other guests' activities in their rooms.

According to a second aspect of the invention, an Internet site is established through which the public may observe the images of the guests either by purchasing a membership to access the images, by purchasing a sold copy of the images, or through some other commercial purpose associated with the lodging facility. According to a third aspect of the invention, the guests' rooms may be categorized by the type of activity which the lodging facility expects will occur in the room, by a particular room theme, or by some other criteria. The rooms may also be equipped with toys, games or equipment necessary to enhance desired activities.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a block diagram of a network of image collecting and distributing devices configured according to an embodiment of the present invention;

FIG. 2 is a flow diagram of a method of collecting and distributing images of guests to a lodging facility according to an embodiment of the invention; and

FIG. 3 is an example of a consent form for use with the present invention.

### DETAILED DESCRIPTION OF EMBODIMENTS OF THE INVENTION

As discussed above, aspects and embodiments of the present invention relate to a lodging facility configured to collect and distribute images of guests and their activities in rooms of the lodging facility. As used herein, the term “lodging facility” is intended to mean and include businesses which provide bedrooms for guests to use on a daily or hourly basis in exchange for value. Examples of “lodging facilities” include hotels, motels, inns, bed-and-breakfasts, and the like. Such “lodging facilities” may also provide other rooms and services in addition to providing bedrooms, but at a minimum provide bedrooms for use by guests in exchange for value. Also as used herein, the term “image” is intended to mean and include any visual, audio or other sensory input which may be converted to an electronic signal representing the sensory input such as a moving or still picture, a sound, and the like.

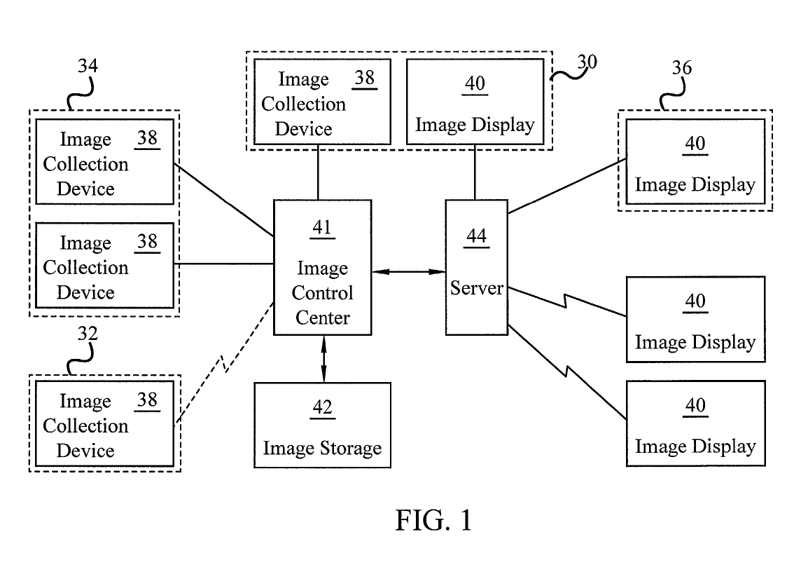

A block diagram of an exemplary image collection and distribution system for a lodging facility is shown in FIG. 1. According to a first aspect of the invention, each of a plurality of rooms 30, 32, 34 and 36 within a lodging facility is adapted to include one or more of an image collection device 38 and an image display 40. An image collection device may take the form of any conventional video recording machine, a motion or still camera, a web camera, an audio recorder, movement sensor and the like. The image collection device 38 may be configured to collect either digital or analog signals, but at a minimum includes the capacity to collect one or both of a visual (or video) and an audible (or audio) image of occurrences within the room in which it is installed. Conventional image collection devices are well known in the art and come in all shapes and sizes so that they may be prominently displayed on, for example, a wall of the room, or more discretely hidden into a painting or other object within the room. While any image collection device would suffice, several exemplary image collection devices include the Remington 900 MHz Wireless Observation System, the Lorex 6040 Audio/Video Wireless Camera, and the Sony CCD Pinhole Board Audio/Video Camera, all sold by 123 CCTV Security Camera Surveillance Equipment of Bakersfield, Calif. An image display 40 may take the form of any conventional device for producing the images collected by an image collection device for observation by an observer such as through a speaker or a visual display, and the like. Visual displays may include any visual display known in the art (e.g., a cathode ray tube (“CRT”), plasma display, and liquid crystal display (“LCD”) and/or a display based on light emitting diodes (“LED”)), and may be of any desired configuration, such as a square, rectangle, etc. Several exemplary commercial image displays include a computer display, a television, a radio, a speaker, a video cassette player, a digital video disk player (DVD), and the like.

The image display 40 may also include an interface for interacting with the information, images and options displayed on the image display 40, though in some embodiments no interface is required. If employed, the interface may include any device configured to interact with a processor associated with the display to select, remove, add to or otherwise alter the information displayed. Examples of common interfaces include a 10-key pad or alphanumeric keyboard, a touchpad or other touch sensitive surface, or one or more buttons or keys, such as a numbered key for each room in the lodging facility which, when pressed, displays one or more images of activities within that room. Alternatively, a touchscreen input may be used as both the image display 40, and the interface (see U.S. Pat. No. 5,951,397 to Dickinson (Sep. 14, 1999)). Such interactive devices and displays are commonly known and used such as in conjunction with a personal computer.

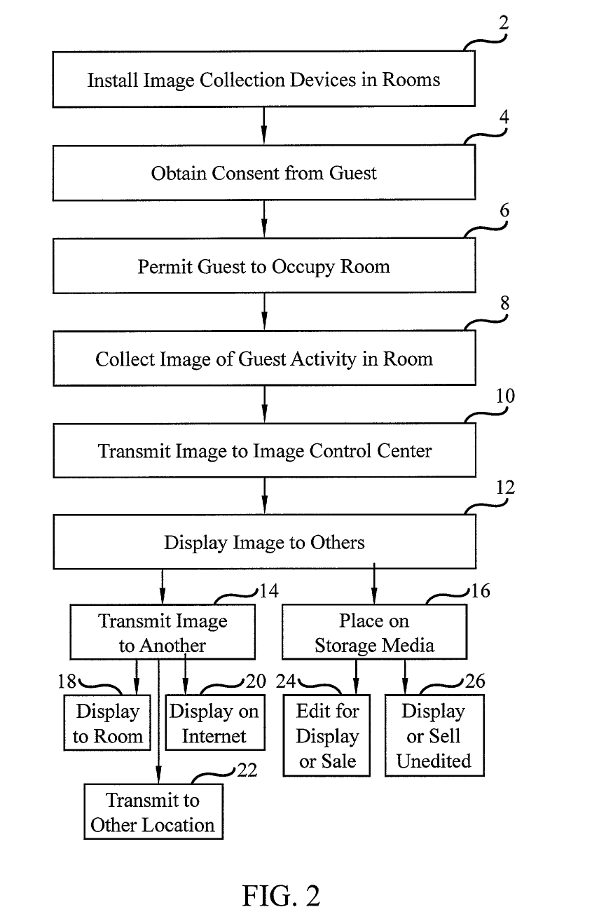

In a simple embodiment of this first aspect of the invention, each room may have a single image collection device 38 mounted somewhere within the room, such as on a wall, or placed at another location from which images of activities within the room may be collected. In the particular embodiment shown in FIG. 2, rooms 30 and 32 each include only one image collection device 38. The image collection devices 38 may be connected to other associated equipment by any communications connection known in the art. Some examples of communications connections may include, without limitation, electronic or other data transferring cable (including optical as well as electrical), radio frequency wave transmissions including cellular frequency transmissions as well as microwave, satellite dish frequencies, etc., phone lines (again both optical and electrical) and the like, such as is common with remote communication systems.

For the embodiment of FIG. 2, room 30 is connected to an image control center 41 by a coaxial cable, and room 32 is connected to the image control center 41 by a wireless image collection device, as indicated by the dotted connection line. Room 34 includes two image collection devices 38 placed at different locations within the room to collect more than one image of the activities within the room 34. It will be clear to those of ordinary skill in the art that any number of image collection devices 38 may be included within a room for collecting desirable images of guest activities within the room. For example, it may be desirable in an embodiment of the invention configured for a bedroom to place a visual image collecting device directly over the bed, and several at various angles toward the bed to collect video images of activities occurring on and around the bed from a variety of angles, and several audio collecting devices on or near the bed to collect audio images of the same activities. In other embodiments, it may be desirable to orient and place image collection devices in a room to collect images of activities at other additional locations such as at a table, a jacuzzi, a kitchen, a couch, a bathroom, or other location at which guests may engage in activities which others would like to see.

The collected images may be stored in association with the image collection devices 38 within each room, such as on a magnetic tape or digital storage device within or associated with the image collection device 38. Alternatively, or additionally, the collected images may be transmitted to an image control center 41 directly or remotely associated with each of the image collection devices 38. At the image control center 41, the collected images may be monitored and may optionally be stored on an associated image storage device 42 such as a local hard drive, random access memory (RAM), compact disk (CD), digital video disk (DVD), video casette, or other magnetic or electronic data storage medium. The image storage device 42 may be used for any number of data storage functions common to a processor, but is particularly useful for storing collected images and other data and software necessary for the operation of the image control center 41, such as an operating system and application software. Additionally, in the embodiment of the invention shown in FIG. 1, a server 44 is associated with the image control center 41 to provide access to the collected images from sites remote to the image control center 41. The server 44 may be any server for providing multiple users with access to common information such as a computer network server or other server which conventionally operates as a local area network (“LAN”) and/or a wide area network (“WAN”), or as an Internet server.

The image display 40 and any associated interaction may also be implemented through an Internet or Intranet server as an Internet or Intranet display to be viewed by at least one Internet browser. In this way, observation of the collected images may be accomplished with only a connection to the server through a conventional phone or other data transmission line, digital signal line (“DSL”), T-1 line, coaxial cable, fiber optic cable, or other communications connection known in the art. It will also be understood by those of ordinary skill in the art that enhanced bandwidth of digital wireless communications may render such technology suitable for some or all communications according to the present invention, particularly if such communications are encrypted. It will be further understood and appreciated by those of ordinary skill in the art that higher data transmission speeds may be useful for enhancing the sophistication and response of the display and interaction with the observer. In a particular embodiment of the invention, an Internet site is established whereby observers at locations remote to the image control center 41 may access images of the guests and their activities through the Internet. One advantage of an Internet embodiment is that observers may access an Internet image display page from any location where an Internet connection and computer, or other Internet facilitator, such as the so-called “WebTV” boxes, is available. Alternatively, observers with direct connections to the server, such as within a room at the lodging facility, may directly access the collected images. Rooms 30 and 36 each include an image display 40 whereby guests may selectively observe the activities of other guests at the lodging facility, or may access an archive of guest images stored within the image storage device 42.

As used herein, the term “Internet” means and includes a plurality of mutually remote sites having the capability of communicating digital information, at least in part, through communication channels owned or controlled by third parties and being directed and, where necessary, relayed by servers or other suitable apparatus. Such communication channels may include, without limitation, electronic or other data transferring cable (including optical as well as electrical), radio frequency wave transmissions including cellular frequency transmissions as well as microwave, satellite dish frequencies, etc., phone lines (again both optical and electrical) and the like, such as is common with remote communication systems.

FIG. 2 includes a flow diagram of a method of collecting and distributing images of guests at a lodging facility according to an embodiment of the invention. At least one image collection device is installed into each of a plurality of rooms within the lodging facility (step 2) for collecting images of the activities of the guests within the rooms. The image collection devices may be installed when the lodging facility is built, or at a later time by adapting or retrofitting the lodging facility with appropriate image collection devices and coupling the image collection devices to an image control center by either direct wiring or wireless connection, or by operating each room with separate image storage devices. The image collection devices may further be controlled directly through the image control center, may be configured to automatically collect all images, or one or more of the image collection devices within the room may be controllable by a guest within the room.

When a guest arrives at the lodging facility, or at some point before the guest is permitted to occupy a room with an image collection device, the guest gives his or her consent to allow the lodging facility to collect images of the guest's activities and use those images for the lodging facility's commercial purposes (step 4). Those commercial purposes may include such use as use of the images in advertising for the facility, display of the images on the Internet, and selling edited versions of the images. To encourage guests to participate in the image collection program, the lodging facility may offer a reduced rate on rooms, goods or services at the lodging facility, a free stay at the lodging facility, or other promotional items in exchange for the use of the guests' images for the lodging facility's commercial purposes. Alternatively, the lodging facility could offer a guest a share of the money raised from sharing that guest's images, for example an amount based upon the number of observers to that guest's images.

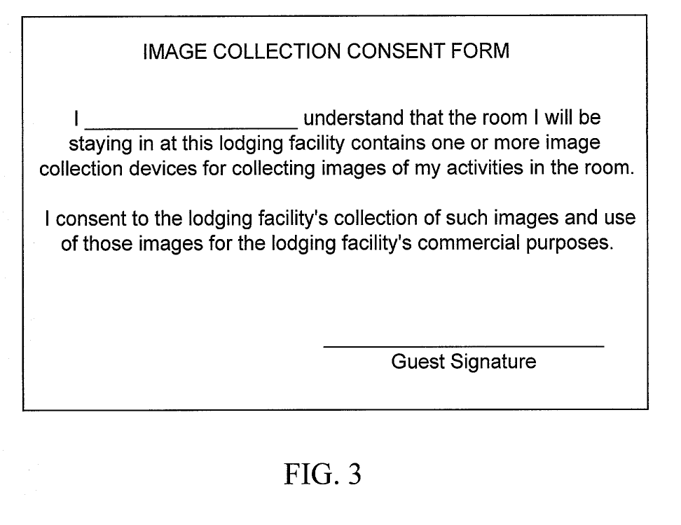

At some point prior to occupying a room, a guest may be asked to sign an Image Collection Consent Form such as is shown in FIG. 3, or to otherwise provide consent to the lodging facility. For example, the guest may acknowledge consent by making an entry at a computer terminal configured to obtain consent from a guest, by checking a box on a reservation form at a reservation desk, by verbally granting consent to a reservation clerk or other employee of the lodging facility, or by merely entering and occupying a room where the understanding is that images of all activities may be collected and used for the lodging facility's commercial purposes. In one particular embodiment of the invention, the consent is obtained as part of a conventional reservation and check-in process for the lodging facility at a reservation desk. In another embodiment of the invention, the consent is obtained at a specific location separate from the reservation desk of the lodging facility. In any case, there is a consent collection point at which the lodging facility obtains consent from a guest to collect and use the images of the guest's activities within the room for the lodging facility's commercial purposes. After consent has been obtained from the guest, the guest is permitted to occupy the room (step 6). Once the guest has occupied the room, images of the guest's activities within the room are collected (step 8) and, for the embodiment of FIG. 2, transmitted to an image control center (step 10).

According to a second aspect of the invention, the collected images are made available for observation by others. Once the images are collected (steps 2, 4, 6, 8 and 10), the images are displayed to others (step 12) through any of a variety of ways. Initially, the images may be transmitted to others (step 14) through displaying them through an image display within a room of the lodging facility (step 18), displaying them through an image display associated with an Internet connection (step 20), or otherwise transmitting the collected images to another location (step 22) for observation by another. When transmitting the images to others, the images may be transmitted substantially simultaneously with collection of the images, meaning that the images are delayed only by the ordinary delays inherent within the image collection and transmission systems or with minor delays added to improve signal quality or coordinate with another event. Alternatively, the images may be intentionally delayed for a predetermined period of time to allow for editing, censoring, categorizing, enhancing and the like. Additionally, the images may be placed on storage media (step 16) for later use. The storage media may include the image storage device 42 shown in FIG. 1 and described with reference thereto, or may include any other image storage device known in the art. The images which are placed on storage media may then be edited for display or sale (step 24), or may be displayed or sold unedited (step 26).

The following example is a description of a lodging facility and its operation configured according to one specific embodiment of the invention to illustrate how the methods and system described herein may be applied commercially. In one particular embodiment of the invention a hotel is established wherein a plurality of bedrooms are each configured such that at least one video camera is aimed at a bed in the bedroom and at least one microphone is appropriately placed to collect visual and audio images of guests within the bedroom. Multiple video cameras and microphones may also be used. The orientation and placement of the video cameras within each room is configured such that any intimate activities of guests on or near the bed may be easily observed. In addition to an obvious video camera aimed at the bed, hidden cameras and microphones may be used to collect unusual and unobvious images of guests. Additionally, other areas of the guest's room may be configured as a focal point for image collection.

The rooms may further be configured as theme rooms having themes to promote certain activities or fantasies from the guests. Examples of some themes may include, but are not limited to, a medieval England castle room, a valentines room, a winter wonderland room, a jungle room, a wet and wild room, a Venice Italy room, an Elvis room, rooms adorned for various fetishes, and the like. The use of theme rooms in a hotel or other lodging facility is already known in the art. Examples of lodging facilities which include theme rooms is the Anniversary Inn of Salt Lake City, Utah, the Leucadia Inn of San Diego, Calif., and the Quality Inn of Winnipeg, Manitoba.

The rooms of a hotel configured according to embodiments of the invention may also be categorized according to particular activities or types of images of which the lodging facility desires to collect images. Such activities may include but are not limited to family fun, hot tubbing, intimate encounters between people of various sexual preferences or performing various intimate acts, and the like, and other specific activities or images which may be desirable for the commercial purposes of the lodging facility. The specific categories should be chosen by the particular hotel and choice of the various categories may be adjusted as demand for images within the various categories is determined or changes. The rooms may also be equipped with toys or equipment necessary to enhance desired activities. The hotel may also optionally establish guidelines for which areas of the room may be viewed by others, what times of the day images of the guests' activities will be collected, what types of images will be collected, and the like, so that a wider variety of guests will participate in the program.

When a guest checks-in to a hotel configured according to this specific embodiment of the invention, the guest is reminded by a reservation clerk that each of the hotel rooms includes automatic video and audio image recording devices and that any activities in the hotel room may be recorded and used for the hotel's commercial purposes. These commercial purposes may include displaying the images to other guests at the hotel, displaying the images on the hotel's web site, using the images in advertising for the hotel, selling the images to another group, storing the images on a storage media and selling the image, and editing and displaying or selling the images, and even using the images to promote or discover talent for movies or commercials, or using the images in a movie or commercial. The commercial purposes may also include selling edited or unedited copies of the images to the guest. The guest is then asked to sign an image collection consent form and, after the guest and any companions to the guest, sign the form, the guest is given a key to the room. In determining which room to assign to a guest, the reservation clerk may ask the guest for the guest's preferences as to a particular theme room or room category for image collection.

Images of the guest and the guest's activities are then automatically collected and transmitted back to an image control center within the hotel. In a specific embodiment of the invention, an image director monitors image collection among the various rooms and determines whether a change in camera view or microphone volume within a room should be done, or whether other special effects should be added to the images, such as music, lighting, and the like, or whether other adjustments should be made to the image collection to increase the value of the collected images. The image collection director may also organize and categorize the collected images for display to others. Rooms within the hotel of the present specific embodiment each also include an image display, such as a personal computer with an Internet connection or other server connection, or a “Web TV” unit, through which guests may observe the images of their own activities or those of other guests. In a particular embodiment of the invention, each room is provided with an interactive display through which guests may access and observe other guests' activities in their rooms and send messages to and receive messages from the other guests relating to their activities. The images are also made available to others within a membership group which can access the images through the Internet, and by printing either edited or unedited copies of the images for public or private sale. The images may even be provided so that a guest may purchase an edited or enhanced memorabilia copy of the guest's activities at the hotel. To display the images through the Internet to a controlled group of people, the hotel may establish a membership group by collecting contact information from and assigning a personal identification number and password to a select group of people to whom the hotel sells, for a membership fee, or distributes a membership subscription as is commonly done in the Internet art to restrict access to certain Internet sites.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A lodging facility comprising:
a plurality of rooms, each including at least one device configured to collect at least one image of a guest activity in the room; and
a consent collection point configured to permit a guest to occupy one of the plurality of rooms upon the guest consenting to the lodging facility's use of an image of the guest's activities within the room for the lodging facility's commercial purposes.

2. The lodging facility of claim 1, wherein the at least one image comprises an electronic representation of at least one of a visual image and an audio image.

3. The lodging facility of claim 1, wherein the at least one device includes a plurality of devices each configured to collect at least one image.

4. The lodging facility of claim 1, wherein the device in each of the rooms is further configured to transmit the at least one image to an image control center.

5. The lodging facility of claim 4, wherein the image control center includes an Internet server associated therewith and configured to display at least one of the collected images on the Internet.

6. The lodging facility of claim 5, wherein the Internet server is further configured to display the image on the Internet substantially simultaneous with collecting the image.

7. The lodging facility of claim 5, wherein the Internet server is further configured to display an edited version of the image on the Internet.

8. The lodging facility of claim 4, wherein the image control center further includes an image storage device associated therewith and configured to store at least a portion of the images collected from the rooms.

9. The lodging facility of claim 1, wherein the consent collection point is further configured to provide the guest one of a discounted stay, a free stay and a promotional item in exchange for consent to use the image for the lodging facility's commercial purposes.

10. The lodging facility of claim 1, wherein each of the plurality of rooms further comprises one or more of a toy and a game to encourage particular activities within the room.

11. The lodging facility of claim 1, wherein each room is categorized by a type of image the lodging facility desires to collect from that room.

12. The lodging facility of claim 1, wherein each room is categorized by a room theme.

13. The lodging facility of claim 1, wherein each room includes at least one hidden device configured to collect the image.

14. The lodging facility of claim 1, wherein each room includes at least one non-hidden device configured to collect the image.

15. The lodging facility of claim 1, wherein whether each of the devices receives an image is controlled by the lodging facility.

16. The lodging facility of claim 1, wherein each device is further configured to automatically receive the at least one image.

17. The lodging facility of claim 1, wherein a portion of the plurality of rooms further each comprises a display configured to allow a guest to select one of the plurality of rooms and observe an image of an activity occurring within that room.

18. A method for operating a lodging facility, the method comprising:
providing at least one device configured to collect an image in each of a plurality of rooms associated with the lodging facility; and
permitting a lodging facility guest to occupy one of the plurality of rooms in exchange for the guest's consent to have images of the guest's activities within the room to be collected and used for the lodging facility's commercial purposes.

19. The method of claim 18, wherein providing at least one device configured to collect an image comprises providing a plurality of devices configured to collect an image in each of the plurality of rooms.

20. The method of claim 18, wherein providing at least one device configured to collect an image comprises providing a hidden device configured to collect an image.

21. The method of claim 18, further comprising collecting an image of the guest's activities within the room.

22. The method of claim 21, further comprising displaying the image of the guest's activities on the Internet.

23. The method of claim 22, wherein displaying the image on the Internet comprises displaying the image substantially simultaneous with collecting the image.

24. The method of claim 21, further comprising storing the collected image of the guest's activities within the room.

25. The method of claim 24, further comprising editing the collected image of the guest's activities within the room.

26. The method of claim 25, further comprising displaying the edited image on the Internet.

27. The method of claim 25, further comprising storing the edited image on an image storage device.

28. The method of claim 22, wherein displaying the image of the guest's activities on the Internet comprises arranging access to the image with access to other images of other rooms associated with the lodging facility, such that access to each image is categorized by a type of activity occurring in the image.

29. The method of claim 18, further comprising having the guest select a room theme in which to have the image collected.

30. The method of claim 18, further comprising having the guest select a type of activity to participate in for the image to be collected.

31. The method of claim 30, further comprising assigning a room to the guest based upon the type of activity selected.

32. The method of claim 18, further comprising allowing the guest to use the room at one of a discounted rate and a free rate in exchange for consent to use the image for the lodging facility's commercial purposes.

33. The method of claim 18, further comprising establishing a membership group to observe images collected from the plurality of rooms.

34. The method of claim 33, further comprising charging a membership fee to the membership group in exchange for access to the images.

35. The method of claim 34, further comprising allowing a member to access the images by reference to a type of activity the member desires to see.

36. The method of claim 27, further comprising selling copies of the edited images.

37. The method of claim 18, further comprising maintaining control at the lodging facility over whether each of the devices collects an image.

38. The method of claim 18, further comprising automatically collecting the image from the room.

39. The method of claim 18, further comprising placing at least one display in each of at least a portion of the plurality of rooms and configuring the display to allow a guest to select one of the plurality of rooms and observe an image of an activity occurring within that room.

40. A method of collecting and distributing images of guests to a lodging facility for commercial purposes, the method comprising:
providing at least one device configured to collect an image in each of a plurality of rooms associated with the lodging facility; and
permitting a guest to the lodging facility to occupy one of the plurality of rooms in exchange for the guest's consent to allow the image from the room the guest occupies to be used for the lodging facility's commercial purposes
collecting an image of the guest's activities in the room; and
displaying the image of the guest's activities for profit.

41. The method of claim 40, wherein placing at least one device configured to collect an image comprises placing a plurality of devices configured to collect an image in each of the plurality of rooms.

42. The method of claim 40, wherein providing at least one device configured to collect an image comprises providing a hidden device configured to collect an image.

43. The method of claim 40, further comprising displaying the image of the guest's activities on the Internet.

44. The method of claim 43, wherein displaying the image over the Internet comprises displaying the image substantially simultaneous with collecting the image.

45. The method of claim 40, wherein displaying the collected image for profit comprises displaying the collected image on the Internet for access to members who have purchased a membership to access the Internet site.

46. The method of claim 40, wherein displaying the collected image for profit comprises displaying the collected image on the Internet in association with advertising.

47. The method of claim 40, wherein displaying the collected image for profit comprises placing at least a portion of the collected image on a display media and selling the display media.

48. The method of claim 40, wherein displaying the collected image for profit comprises establishing a site for displaying the collected images, the site configured to display the collected images by type of activity displayed through the images.

49. The method of claim 40, further comprising having the guest select a theme room in which to have the image collected.

50. The method of claim 40, further comprising having the guest select a type of activity of which the image will be collected.

51. The method of claim 50, further comprising assigning a room to the guest based upon the type of activity selected.

52. The method of claim 40, further comprising permitting the guest to occupy the room at one of a discounted rate and a free rate in exchange for consent to use the image for the lodging facility's commercial purposes.

53. The method of claim 40, wherein displaying the collected image for profit comprises selling edited copies of the collected images.

54. The method of claim 40, further comprising maintaining control at the lodging facility over whether each of the devices collects an image.

55. The method of claim 40, wherein collecting an image comprises automatically collecting the image.

56. The method of claim 40, further comprising providing at least one display in each of at least a portion of the plurality of rooms and configuring the display to allow a guest to select one of the plurality of rooms and observe an image of an activity occurring within that room.
